(19) United States
(12) Patent Application Publication
(10) Pub. No.: US 2024/0244492 A1
(43) Pub. Date: Jul. 18, 2024

(54) METHOD AND APPARATUS FOR SELECTING CELL IN WIRELESS COMMUNICATION SYSTEM

(71) Applicant: SAMSUNG ELECTRONICS CO., LTD., Suwon-si (KR)

(72) Inventors: Nishant Nishant, Bangalore (IN); Amit Anandrao DANGE, Bangalore (IN); Aman AGARWAL, Bangalore (IN); Kailash Kumar JHA, Bangalore (IN)

(21) Appl. No.: 18/415,516

(22) Filed: Jan. 17, 2024

Related U.S. Application Data
(63) Continuation of application No. PCT/KR2024/000775, filed on Jan. 16, 2024.

(30) Foreign Application Priority Data
Jan. 17, 2023 (IN) 202341003297

(51) Int. Cl. H04W 36/00; H04W 36/30

(52) U.S. Cl. CPC H04W 36/0069; H04W 36/0085; H04W 36/302

(57) ABSTRACT

An example provides a method for selecting a cell by a user equipment (UE) in a wireless communication system, and the method may include receiving first configuration information for early measurement to be performed while the UE is in an idle state or an inactive state. The method may include identifying, based on the first configuration information, a plurality of candidate cells for the early measurement among neighboring cells of the UE. The method may include receiving, from each candidate cell of the plurality of candidate cells, second configuration information including at least one of bandwidth support information, high power user equipment (HPUE) support information or relaxed measurement support information. And the method may include selecting a cell by prioritizing the plurality of candidate cells, based on a signal strength of said each candidate cell and the second configuration information.

### CROSS-REFERENCE TO RELATED APPLICATIONS

This application is a continuation of International Application No. PCT/KR2024/000775 designating the United States, filed on Jan. 16, 2024, in the Korean Intellectual Property Receiving Office and claiming priority to Indian Complete Patent Application No. 202341003297 filed on Jan. 17, 2023 in the Indian Patent Office, the disclosures of each of which are incorporated by reference herein in their entireties.

### BACKGROUND

### Field

The disclosure relates to an electronic device, and more specifically, to a method and a User Equipment (UE) for selecting a cell.

### Description of Related Art

Fifth Generation (5G) cellular networks aim to provide a higher data rate experience, good coverage and reduced delay to a User Equipment (UE) as much as possible. Features of the 5G cellular networks such as Carrier Aggregation (CA) and Dual Connectivity (DC), etc. allow the UE to utilize resources from multiple cells with the same or multiple RAT support, which improves the data throughput performance of the UE. To reduce a delay in setting up the DC/CA, an early measurement reporting feature of the 5G cellular networks ensures quick and early reporting of measurement information availability from neighbour and serving cells in an idle/inactive mode of the UE. In 3GPP Release-16, there are two new parameters broadcasted in an NR SIB1 message and an LTE SIB2 message for the early measurement of EUTRA & NR cells, if available when the UE is in the idle/inactive state. idleModeMeasurementsEUTRA and idleModeMeasurementsNR are the two new parameters in the NR SIB1 message. idleModeMeasurements and idleModeMeasurementsNR are the two new parameters in the LTE SIB2 message.

The idleModeMeasurementsEUTRA indicates that the UE is configured for EUTRA idle/inactive measurements. The UE shall perform the measurements while camping in this cell and report the availability of these measurements when establishing or resuming a connection in this cell. If absent, the UE is not required to perform EUTRA idle/inactive measurements. The idleModeMeasurementsNR indicates that the UE is configured for NR idle/inactive measurements. The UE shall perform the measurements while camping in this cell and report the availability of these measurements when establishing or resuming the connection in this cell. If absent, the UE is not required to perform NR idle/inactive measurements.

With these parameters, a gNodeB (gNB) can indicate if the gNB can process early measurement results for an NR and LTE carrier measurement shared by the UE. A network may request the UE to measure the NR carriers in RRC_IDLE or RRC_INACTIVE via system information or via dedicated measurement configuration in RRC Connection Release. Further, the UE performs the requested measurements and indicates the availability of measurement reports to the gNB during the RRC connection setup or resume procedure. Further, the network may request the UE to report those measurements after security activation. The request for the measurements can be sent by the network immediately after transmitting a security mode command (i.e., before the reception of the security mode complete from the UE). Alternatively, during connection resume from a suspended RRC connection or RRC_INACTIVE state, the gNB can request the UE to provide the idle/inactive measurement results in the RRCConnectionResume message and then the UE can include the available measurement results in the RRCConnectionResumeComplete message. This way the UE in the idle state, an idle with suspended state, or the inactive state can be configured with NR early measurements to support the fast setup of EN-DC (i.e. euCA is extended to support NR measurements).

FIG. 1 is a flow diagram illustrating a conventional method for early measurement reporting for fast CA/DC setup. At 11, the network (NW) releases an RRC connection with measIdleConfig IE which will have the NR or EUTRA frequencies for early measurement. At 12, the UE performs an idle mode measurement for DC/CA capable frequencies. At 13, once the UE establishes the RRC connection, then the UE sends an idleMeasAvailable indication in the RRCSetupComplete message to the network. At 14, the NW responds with the measurement result of early measurement frequencies in the UEInformationRequest message to the UE. At 15, the UE then sends UEInformationResponse with measResultIdleNR/EUTRA to the NW. At 16, the UE receives an RRC reconfiguration message for SCell/SCG configuration from the NW. At 17, if the RRCReconfiguration contains Scellstate set as activate, then Scell activates immediately, but if that IE is set as deactivate or if that IE is not present, then Scell will be in a deactivated state.

But even with the support of the early measurement feature, the UE cannot ensure that the best possible cell has been configured by the network if multiple cells are available for UE to choose from. If the UE is configured with a high bandwidth cell during the DC/CA setup, then the UE will be able to utilise more resources to achieve a high data rate possible at that point. Similarly, if a secondary cell is selected based on features supported like NR HPUE & relaxedMeasurement, the can help with better connectivity and power saving when camped on. But as per current implementation, these features are not considered during secondary cell/cell group addition for the DC/CA. Currently, the signal level is considered for the best secondary cell/cell group addition for DC/CA and no other features are considered, as it may lead to lower signal level cell addition. Even if two cells have a minor signal level difference, the best signal condition cell will be considered for fast CA/DC setup and the lower signal level cell will be ignored, even though the lower signal level cell may support other better features. Thus, the current behaviour restricts the device from using its full capacity, if present in the current network, to available services possible to improve user experience.

FIG. 2 illustrates an example conventional scenario of reducing a frequency of measurement by the UE using a relaxed measurement feature configuration. The UE measures NR frequencies (serving or neighbouring) irrespective of mobility state (high, mid or low), and this continues even in a minimum mobility/stationary scenario where cell signal change will be minimal. So, the UE does not need to measure low mobility scenarios frequently. In 3GPP release-16, standards introduced the relaxed measurement feature to avoid such unnecessary measurements to reduce power consumption. The relaxed measurement feature provides valuable information to the UE which helps in reducing the measurement of configured frequencies for cell reselection in the idle/inactive mode. The UE will receive low MobilityEvaluation-r16 and cellEdgeEvaluation-r16 parameters under relaxedMeasurement-r16 IE broadcast in the SIB2 message which helps to evaluate low mobility as well as a position of the UE (e.g., near cell edge or not). So, the UE can allow relaxed measurement if configured criteria is met. The relaxed measurement feature also contains highPriorityMeasRelax-r16 parameter which allows the UE to relax the measurement of high-priority inter frequencies in an idle/inactive state. Using the support of the relaxed measurement in the cell (SIB2 information), the network may configure the UE with the release-17 relaxed measurement feature in connected mode, where the UE can reduce the frequency of serving/neighbour cell measurement in connected mode. This will help the UE to save power consumption and increase battery performance. Compared to a situation designated with reference numeral 21, the UE will reduce the frequency of measurement in the situation designated with reference numeral 22 based on the relaxed measurement feature configuration to save power consumption.

As per the current 3GPP procedure, the UE camped on the NR cell supporting early measurement feature performs measurement of neighbouring NR/LTE frequencies for the fast CA or DC setup and reports the neighbour cells for activating the secondary cell/cell group based on signal level ranking. Even if two neighbour cells have a minor signal level difference, the best signal condition cell will be considered for reporting and the lower signal level cell will be ignored even though the lower signal level cell may support other features. Based on the current procedure, the UE will report the best signal level neighbouring cell as the secondary cell for the DC/CA configuration. This may lead to reporting of lower bandwidth or lower TX power supporting cells as the secondary cell for DC/CA and it will affect services running on UE side. There is a possibility that there can be other neighbour cells, which may not be the best cell in terms of signal level, but may be of higher cell bandwidth supporting features like HPUE, relaxedMeasurement etc., and these can be candidates cell for secondary cell/cell group addition as well. 3GPP standards consider signal level only while selecting a cell during early measurement reporting. It does not consider other parameters while reporting the cells during early measurement to select the cell.

FIG. 3A illustrates a problem in a conventional system for early measurement for higher bandwidth. Consider, a UE 31 is camped on an NR cell supporting release-16 early measurement having “measIdleConfig” IE configured by the network for the NR and LTE frequencies measurement in the idle or inactive mode. As per the current 3GPP specification, the UE 31 selects the cell with the best signal condition as a candidate cell for SCell/SCG addition and reports that cell in the UEInformationRequest. But while reporting the best signal cell, the UE 31 will not check for other cells, which may be of similar signal level and may support other features. The UE 31 will not check if the reported best signal cell is the best possible cell in that situation or not and whether the reported cell will provide higher scheduling resources to the UE 31 or not. Based on the signal condition, the UE 31 might select the best cell with lower band width rather than selecting the cell with higher bandwidth which will affect resource utilization. The network will provide configuration for the addition/activation of SCell even though selecting this cell to provide lower TPUT.

At 34, the UE 31 is camped on the NR cell supporting early measurement in the idle/inactive mode. The UE 31 requires the secondary cell addition for high data rate service triggered. The NW configures the multiple candidate cells 32, 33. The UE 31 can select either cell 1 (32) or cell 2 (33) as both satisfy a condition for measurement report for SCell addition. The UE 31 performs SCell addition to the cell 33 which doesn't support higher bandwidth. The UE 31 will have a lower data rate, and hence the user streaming experience get affected.

FIG. 3B illustrates a problem in a conventional system for early measurement for better coverage and uplink throughput. Consider, the UE 31 is camped on the NR cell supporting release-16 early measurement having “measIdleConfig” IE configured by the network for the NR & LTE frequencies measurement in the idle or inactive mode. As per the current 3GPP specification, the UE 31 selects the cell with the best signal condition as the candidate cell for SCell/SCG addition and reports that cell in the UEInformationRequest.

The UE 31 is camped on the NR cell supporting early measurement in the idle/inactive mode. The UE 31 requires secondary cell addition for high data rate service triggered. The NW configures the multiple candidate cells 32, 33. The UE 31 can select either cell 1 (32) or cell 2 (33) as both satisfy the condition for the measurement report for the SCell addition. The UE 31 performs the SCell addition to the cell 32 which doesn't support HPUE. Further, the UE 31 will have poor coverage in the cell edge area, and user experience gets affected. Thus, the UE 31 will not take into account if the other cell under the same situation supports any additional feature like HPUE which will provide higher TX power compared to a non-HPUE cell which will improve device connectivity in the cell edge area. Even the UE 31 would have a chance to report HPUE supported cell to get better coverage and Tx power, but, with the current implementation, the UE 31 will not prefer any feature over the signal condition for fast CA/DC setup. The network will provide configuration for the addition/activation of SCell affecting user performance and coverage.

FIG. 3C illustrates a problem in a conventional system for early measurement for power saving. Consider, the UE 31 is camped on the NR cell supporting release-16 early measurement having “measIdleConfig” IE configured by the network for NR & LTE frequencies measurement in the idle or inactive mode. As per the current 3GPP specification, the UE 31 selects the cell with the best signal condition as the candidate cell for the SCell/SCG addition and reports that cell in the UEInformationRequest. But while reporting the cell for fast CA/DC setup, with the current implementation, the UE 31 will not consider support of release-17 relaxed measurement feature support in the cell, which would have helped the UE 31 to reduce power consumption after the CA/DC addition.

At 38, the UE 31 is camped on the NR cell supporting early measurement in the idle/inactive mode. The UE 31 requires the secondary cell addition for high data rate service triggered. The NW configures the multiple candidate cells 32, 33. The UE 31 can select either the cell 1 (32) or the cell 2 (33) as both satisfy the condition for measurement report for SCell addition. At 37, the UE 31 performs SCell addition to the cell 1 (32) which doesn't support relaxedMeasurement. The UE 31 will consume power for unnecessary measurement, and hence the user will experience poor battery performance. The network will provide configuration for the addition/activation of SCell even though selecting this cell will provide poor battery performance.

Thus, it would be desirable to provide a useful alternative for choosing an appropriate secondary cell to avoid the aforementioned problems.

### SUMMARY

The present disclosure provides a method and apparatus for selecting a cell efficiently in a wireless communication system.

The example embodiments can provide a method and a UE for prioritizing a secondary cell, where the UE supports a Dual Connectivity (DC)/Carrier Aggregation (CA) configuration. A UE camped on an NR cell supporting early measurement feature to measure neighbouring NR/LTE frequencies for CA or NR-DC configuration can quickly setup and activate the secondary cell for additional resources. In an example embodiment, the UE can report cells by prioritizing the highest bandwidth cell in an idle mode measurement report of Rel-16 early measurement reporting. So, the UE will have maximum bandwidth available for higher data throughput. This can, for example, help the UE to acquire the best possible secondary cell supporting early measurement for enhanced user experience.

The example embodiments can prioritize and select a secondary cell (Scell) based on higher bandwidth support mentioned in system information, if more than one cell satisfies the criteria for measurement report for the addition of Scell to achieve maximum TPUT possible at that time. If a UE has an option to choose from an HPUE cell and a non-HPUE cell, then the UE can choose a cell supporting HPUE so that it will have better coverage in addition to higher DL/UL TPUT with increased TX power. This can, for example, help the UE to configure the best possible secondary cell to have higher TPUT, better coverage and save power depending on the cell selected.

The example embodiments can prioritize and select a secondary cell (Scell) supporting relaxedMeasurement feature to perform measurement relaxation based on stationary and cell edge condition to save power consumption by reducing the frequency of the measurement. This can, for example, help the UE to configure the best possible secondary cell to have higher TPUT, better coverage and save power depending on the cell selected, which will enhance the 5G experience and boost device performance at the same time. The systems and methods of this disclosure can be extended to NE-DC and MR-DC cases based on the Dual-Connectivity band parameters indicated by the network.

Accordingly, an example embodiment can provide a method for selecting a cell by a user equipment (UE) in a wireless communication system, the method may include receiving first configuration information for early measurement to be performed while the UE is in an idle state or an inactive state. The method may include identifying, based on the first configuration information, a plurality of candidate cells for the early measurement among neighboring cells of the UE. The method may include receiving, from each candidate cell of the plurality of candidate cells, second configuration information including at least one of bandwidth support information, high power user equipment (HPUE) support information or relaxed measurement support information. And the method may include selecting a cell by prioritizing the plurality of candidate cells, based on a signal strength of said each candidate cell and the second configuration information.

In an embodiment, wherein the selected cell is a cell to be added for a dual connectivity (DC)/carrier aggregation (CA) of the UE in the wireless communication system supporting the DC/CA.

In an embodiment, wherein the UE receives the first configuration information from a primary cell on which the UE camped, and wherein the selected cell is a secondary cell for the DC/CA of the UE.

In an embodiment, wherein the first configuration information includes available frequency information about at least one of a new radio (NR) or an evolved universal terrestrial radio access (EUTRA), the available frequency information corresponding to the plurality of candidate cells.

In an embodiment, wherein selecting a cell by prioritizing the plurality of candidate cells may include prioritizing the plurality of candidate cells based on the bandwidth support information and a signal strength of said each candidate cell, and selecting the cell with a higher signal strength among at least one cell having a maximum bandwidth in the plurality of prioritized candidate cells.

In an embodiment, wherein selecting a cell by prioritizing the plurality of candidate cells may include prioritizing the plurality of candidate cells based on the HPUE support information and a signal strength of said each candidate cell, and selecting the cell with a higher signal strength among at least one cell supporting HPUE in the plurality of prioritized candidate cells.

In an embodiment, wherein selecting a cell by prioritizing the plurality of candidate cells may include prioritizing the plurality of candidate cells based on the relaxed measurement support information and a signal strength of said each candidate cell, and selecting the cell with a higher signal strength among at least one cell supporting a relaxed measurement in the plurality of prioritized candidate cells.

In an embodiment, wherein prioritizing the plurality of candidate cells may include prioritizing the plurality of candidate cells in order of satisfying criteria of the bandwidth support information, the HPUE support information and the relaxed measurement support information.

In an embodiment, the method may include transmitting, to a base station of a primary cell of the UE, a radio resource control (RRC) message including information about the selected candidate cell; receiving, from the base station, a request message for requesting measurement for the selected candidate cell, transmitting, to the base station, a response message including a measurement result for the selected candidate cell, and performing a RRC reconfiguration procedure with the selected candidate cell as a secondary cell for the DC/CA.

Accordingly, an example embodiment can provide a user equipment (UE) in a wireless communication system, the UE may include a communicator, at least one processor, and a memory storing instructions that, when executed by the at least one processor, cause the UE to receive first configuration information for early measurement to be performed while the UE is in an idle state or an inactive state. The instructions may cause the UE to identify, based on the first configuration information, a plurality of candidate cells for the early measurement among neighboring cells of the UE. The instructions may cause the UE to receive, from each candidate cell of the plurality of candidate cells, second configuration information including at least one of bandwidth support information, high power user equipment (HPUE) support information or relaxed measurement support information. And the instructions may cause the UE to select a cell by prioritizing the plurality of candidate cells, based on a signal strength of said each candidate cell and the second configuration information.

Accordingly, an example embodiment can provide a non-transitory computer readable storage medium may include one or more programs, the one or more programs comprising instructions that, when executed by at least one processor, cause a user equipment (UE) in a wireless communication system to receive first configuration information for early measurement to be performed while the UE is in an idle state or an inactive state. The instructions may cause the UE to identify, based on the first configuration information, a plurality of candidate cells for the early measurement among neighboring cells of the UE. The instructions may cause the UE to receive, from each candidate cell of the plurality of candidate cells, second configuration information including at least one of bandwidth support information, high power user equipment (HPUE) support information or relaxed measurement support information. And the instructions may cause the UE to select a cell by prioritizing the plurality of candidate cells, based on a signal strength of said each candidate cell and the second configuration information.

These and other aspects of the example embodiments herein will be better appreciated and understood when considered in conjunction with the following description and the accompanying drawings. It should be understood, however, that the following descriptions, while indicating preferred embodiments and numerous specific details thereof, are given by way of illustration and not by limitation. Many changes and modifications may be made within the scope of the embodiments, and the embodiments herein include all such modifications.

### BRIEF DESCRIPTION OF THE DRAWINGS

The above and/or other aspects of the disclosure will be more apparent by describing certain embodiments of the disclosure with reference to the accompanying drawings, in which:

FIG. 1 is a flow diagram illustrating a conventional method for early measurement reporting for fast CA/DC setup;

FIG. 2 illustrates a conventional example scenario of reducing a frequency of measurement by a UE using a relaxed measurement feature configuration;

FIG. 3A illustrates a problem in a conventional system for early measurement for higher bandwidth;

FIG. 3B illustrates a problem in a conventional system for early measurement for better coverage and uplink throughput;

FIG. 3C illustrates a problem in a conventional system for early measurement for power saving;

FIG. 4 is a block diagram of an example UE for prioritizing a secondary cell, according to various embodiments;

FIG. 5 is a flow diagram illustrating an example method for selecting a cell by the UE, according to various embodiments;

FIG. 6 is a flow diagram illustrating an example method for prioritizing the secondary cell, according to various embodiments;

FIG. 7 is a flow diagram illustrating an example method for prioritizing the secondary cell based on a user preference, according to various embodiments;

FIG. 8A illustrates a proposed example solution for the problem in early measurement of high bandwidth, according to various embodiments;

FIG. 8B is a sequential diagram illustrating example signaling between the UE, a master node gNB and two secondary node gNBs for early measurement of high bandwidth, according to various embodiments;

FIG. 9A illustrates a proposed example solution for a problem in early measurement for better coverage and uplink throughput, according to various embodiments;

FIG. 9B is a sequential diagram illustrating example signaling between the UE, the master node gNB and the two secondary node gNBs for better coverage and uplink throughput, according to various embodiments;

FIG. 10A illustrates a proposed example solution for a problem in early measurement for power saving, according to various embodiments; and

FIG. 10B is a sequential diagram illustrating example signaling between the UE, the master node gNB and the two secondary node gNBs for early measurement of power saving, according to various embodiments.

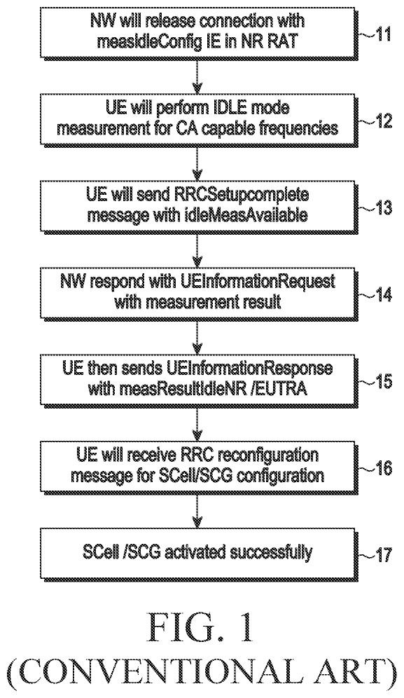

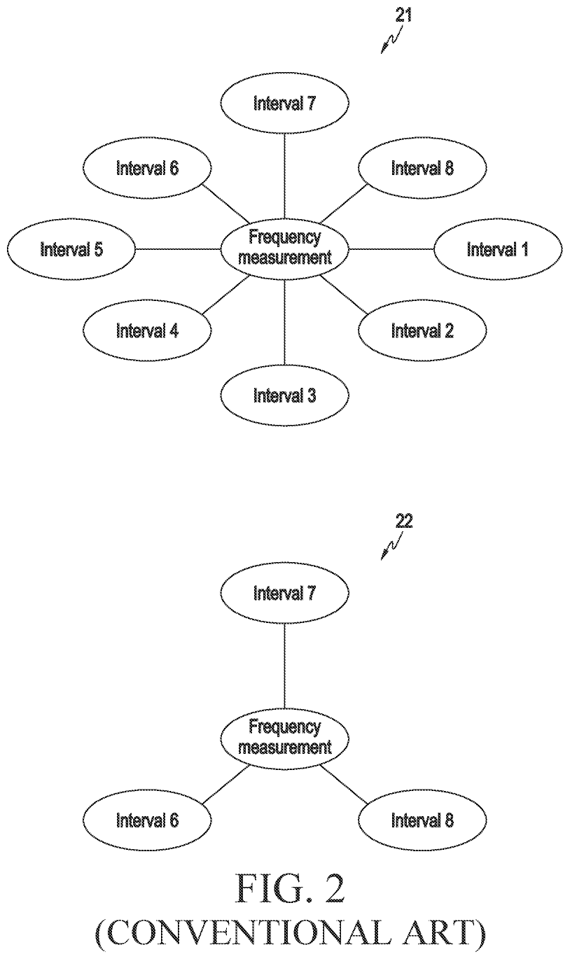

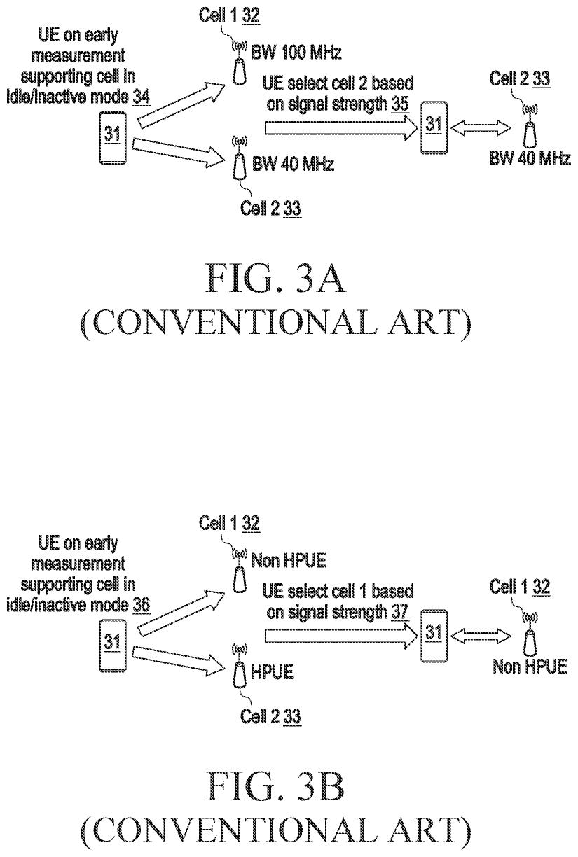

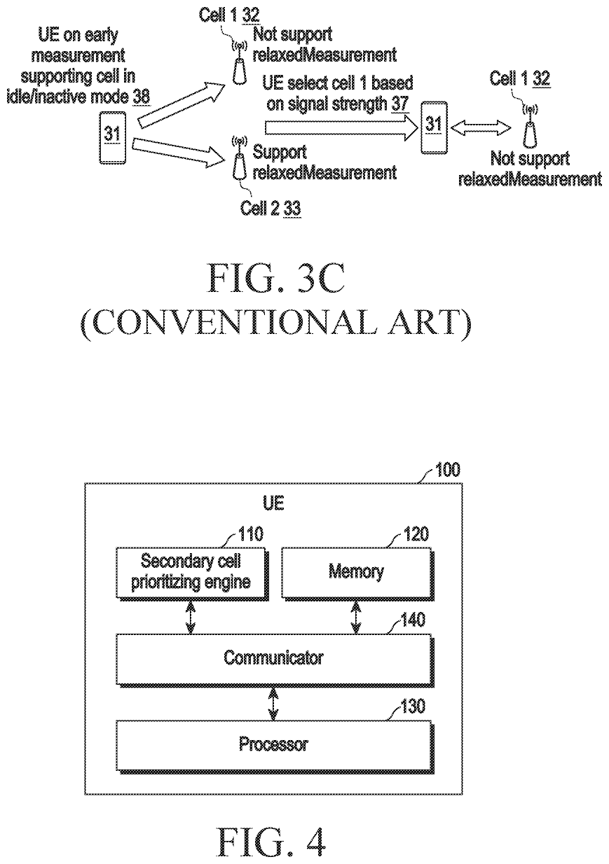

### DETAILED DESCRIPTION

The embodiments herein and the various features and advantageous details thereof are explained more fully with reference to the non-limiting example embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the example embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Presently, a UE camped on an NR cell supporting early measurement features and measuring neighbouring NR/LTE frequencies for CA or NR-DC configuration can quickly set up and activate a secondary cell for more resources. This process will not ensure that the best possible neighbouring cell is added as the secondary cell for Dual connectivity (DC)/Carrier Aggregation (CA) configuration. This may lead to the addition of lower bandwidth or non-HPUE supporting cells as the secondary cell for DC/CA and a device might not, for example, get enough resources to run ongoing data activity smoothly. Also, there may be candidate cells available for selection that support other features like HPUE, relaxedMeasurement, etc. It is up to the UE's proprietary decision to select the target cell in the above scenarios. In accordance with various example embodiments disclosed herein, a UE can report cells by prioritising a highest bandwidth cell in an idle mode measurement report of 3GPP Release-16 early measurement reporting. So the UE will have maximum BW available for higher data TP and increased DL/UL speed of the device. Similarly, if multiple neighbouring cells are available to choose from, the UE can also prioritise cells based on HPUE support or relaxedMeasurement support so that the UE will have better coverage or save power based on the selection of SCell. In accordance with the various example embodiments, a UE can, for example, pick the best (or better) possible cell and make sure that a user has a smooth and enhanced 5G experience.

Existing UEs might select a secondary cell which does not support high bandwidth, HPUE & relaxed measurement. This can lead to service degradation & poor performance in comparison to a UE selecting cells supporting these features. In various example embodiments, NR secondary cells that support high bandwidth, HPUE & relaxed measurement can be prioritized based on IEs broadcasted in an SIB message during SCell addition using early measurement to NR CA/MR-DC configuration. In this way, the UE can have better services without any interruption or compromise to provide an enhanced 5G experience.

Accordingly, the example embodiments herein provide a method for prioritizing a secondary cell for a UE supporting a DC/CA configuration. The method includes identifying, by the UE camped on an early measurement supporting primary cell, a plurality of secondary cells among neighboring cells of the UE; receiving, by the UE, system information related to the plurality of secondary cells from the plurality of secondary cells, where the system information includes one or more of bandwidth support information, High Power User Equipment (HPUE) support information, or relaxed measurement support information; and prioritizing, by the UE, the secondary cell for the UE based on the received system information.

Accordingly, the example embodiments herein provide a UE for prioritizing a secondary cell. The UE includes a secondary cell prioritizing engine, a memory, a processor, where the secondary cell prioritizing engine is coupled to the memory and the processor. The secondary cell prioritizing engine is configured to identify the plurality of secondary cells among the neighboring cells of the UE when the UE is camped on the early measurement supporting primary cell; receive the system information related to the plurality of secondary cells from the plurality of secondary cells, where the system information includes the one or more of bandwidth support information, the High Power User Equipment (HPUE) support information, or the relaxed measurement support information; and prioritize the secondary cell for the UE based on the received system information.

Unlike existing methods and systems, the UE chooses the Scell if more than one Scell satisfies the condition of measurement criteria at the same time for benefits including, but not limited to, maximum TPUT achievable in UE's vicinity, better coverage and improved UL TPUT in cell edge, and power saving by avoiding unnecessary measurement. The example embodiments of the disclosure are highly convenient and beneficial for the UEs to make a quick solution to select a cell based on fitting and preferred result to the end user for enhanced performance. Using the example embodiments, a UE can obtain better throughput and data rate so that an end experience of users can be improved. The UE can obtain better coverage along with a higher uplink data rate at the same time, so the end experience will be boosted. The UE can relax measurement of some frequencies which will save power consumption of the device, so the, end experience will be elevated in terms of, for example, battery performance.

Referring now to the drawings, and more particularly to FIGS. 4 through 10B, various example embodiments are described.

FIG. 4 is a block diagram of a UE 100 for prioritizing a secondary cell (that is, selecting a cell by prioritizing a plurality of candidate cells), according to various embodiments. Examples of the UE 100 include, but are not limited to a smartphone, a tablet computer, a Personal Digital Assistance (PDA), a desktop computer, an Internet of Things (IoT) device, a wearable device, etc. In an embodiment, the UE 100 includes a secondary cell prioritizing engine 110, a memory 120, a processor 130, and a communicator 140. The secondary cell prioritizing engine 110 is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like. The UE 100 may be implemented by including at least one processor and a transceiver. The at least one processor may include at least one of the secondary cell prioritizing engine (that is, a cell prioritizing engine) 110 and the processor 130, and the transceiver may include the communicator 140.

The secondary cell prioritizing engine 110 identifies a plurality of secondary cells (e.g. secondary gNodeB)/(that is, a plurality of candidate cells) among neighboring cells of the UE 100 when the UE 100 is camped on an early measurement supporting primary cell (e.g. primary gNodeB). In an embodiment, the secondary cell prioritizing engine 110 performs the identification of the plurality of secondary cells when the UE 100 is in an idle/inactive mode. The secondary cell prioritizing engine 110 receives system information related to the plurality of secondary cells from the plurality of secondary cells. The system information includes, for example, one or more of bandwidth support information, High Power User Equipment (HPUE) support information, or relaxed measurement support information. Further, the secondary cell prioritizing engine 110 prioritizes the secondary cell for the UE 100 based on the received system information.

In an embodiment, for identifying the plurality of secondary cells among neighboring cells of the UE 100, the secondary cell prioritizing engine 110 receives New Radio (NR) available frequencies and/or Evolved Universal Terrestrial Radio Access (EUTRA) available frequencies that support Dual Connectivity (DC)/Carrier Aggregation (CA) from the early measurement supporting primary cell. Further, the secondary cell prioritizing engine 110 identifies the plurality of secondary cells among the neighboring cells having one of the received frequencies by tuning the UE 100 to each of the received frequencies for receiving the system information.

In an embodiment, for prioritizing the secondary cell for the UE 100 based on the received system information, the secondary cell prioritizing engine 110 determines whether the plurality of secondary cells have a same bandwidth from the bandwidth support information. The secondary cell prioritizing engine 110 prioritizes a cell having a higher bandwidth as the secondary cell in response to the determination that the plurality of secondary cells does not have the same bandwidth. The secondary cell prioritizing engine 110 determines whether a number of cells in the plurality of secondary cells supporting the HPUE from the HPUE support information satisfies a first criteria in response to the determination that the plurality of secondary cells have the same bandwidth. The secondary cell prioritizing engine 110 prioritizes a cell supporting the HPUE as the secondary cell in response to the determination that the number of cells supporting the HPUE satisfies the first criteria.

The secondary cell prioritizing engine 110 determines whether a number of cells of the plurality of secondary cells supporting relaxed measurement from the relaxed measurement support information satisfies a second criteria in response to the determination that the number of cells supporting the HPUE does not meet the first criteria. In an embodiment, the secondary cell prioritizing engine 110 determines a number of cells from a set of cells in the plurality of secondary cells supporting the HPUE or relaxed measurement for verifying the second criteria when the set of cells supports a higher bandwidth as the first criteria. The secondary cell prioritizing engine 110 prioritizes a cell supporting the relaxed measurement as the secondary cell in response to the determination that the number of cells supporting the relaxed measurement satisfies the second criteria. The secondary cell prioritizing engine 110 prioritizes the secondary cell based on a signal strength between the UE 100 and each of the plurality of secondary cells in response to the determination that the number of cells supporting the relaxed measurement does not meet the second criteria.

In an embodiment, the secondary cell prioritizing engine 110 sends a UE InformationResponse message including a measurement of higher bandwidth cells, a measurement of HPUE-supported cells, and a measurement of relaxed measurement supported cells to the primary cell for secondary cell addition upon prioritizing the secondary cell.

In an embodiment, the secondary cell prioritizing engine 110 prioritizes the cell in the plurality of secondary cells as the secondary cell based on the signal strength between the UE 100 and each of the plurality of secondary cells when multiple secondary cells support higher bandwidth, the HPUE and the relaxed measurement.

The memory 120 stores the system information. The memory 120 stores instructions to be executed by the processor 130. The memory 120 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 120 may, in some examples, be considered a non-transitory storage medium. The term “non-transitory” may indicate that the storage medium is not embodied in a carrier wave or a propagated signal. However, the term “non-transitory” should not be interpreted to mean that the memory 120 is non-movable. In various examples, the memory 120 can be configured to store larger amounts of information than its storage space. In various examples, a non-transitory storage medium may store data that can, over time, change (e.g., in Random Access Memory (RAM) or cache). The memory 120 can be an internal storage unit or it can be an external storage unit of the UE 100, a cloud storage, or any other type of external storage.

The processor 130 (including, e.g., processing circuitry) is configured to execute instructions stored in the memory 120. The processor 130 may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor 130 may include multiple cores to execute the instructions. The communicator 140 (including, e.g., communication circuitry) is configured for communicating internally between hardware components in the UE 100. Further, the communicator 140 is configured to facilitate communication between the UE 100 and other devices via one or more networks (e.g. radio technology). The communicator 140 may include, for example, an electronic circuit specific to a standard that enables wired or wireless communication.

Although FIG. 4 shows hardware components of the UE 200, it is to be understood that other embodiments are not limited thereto. In various embodiments, the UE 100 may include a less or a greater number of components. Further, the labels or names of the components are used only for illustrative purposes and do not limit the scope of the disclosure. One or more components can be combined to perform same or substantially similar function for prioritizing the secondary cell.

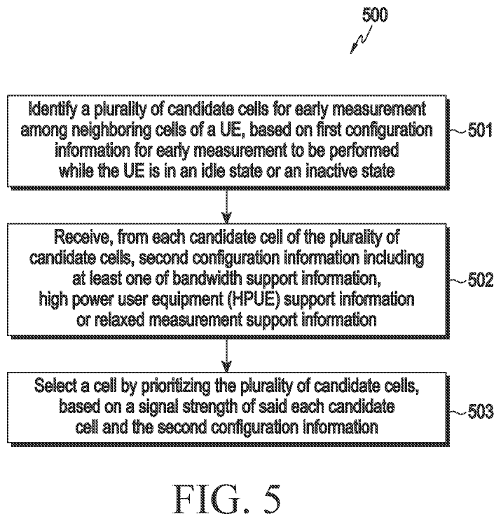

FIG. 5 is a flow diagram 500 illustrating an example method for selecting a cell by the UE 100, according to various embodiments. In an embodiment, the secondary cell prioritizing engine 110 performs steps 501, 502, and 503 of the flow diagram 500. At 501, the method includes identifying a plurality of candidate cells for early measurement among neighboring cells of the UE 100, based on first configuration information for early measurement to be performed while the UE is in an idle state or an inactive state. At 502, the method includes receiving, from each candidate cell of the plurality of candidate cells, second configuration information including at least one of bandwidth support information, high power user equipment (HPUE) support information or relaxed measurement support information. At 503, the method includes selecting a cell by prioritizing the plurality of candidate cells, based on a signal strength of said each candidate cell and the second configuration information.

The example method can help a UE 100 to prioritize the NR secondary/candidate cells that support high bandwidth, HPUE, and relaxed measurement based on IEs broadcasted in an SIB message during SCell addition using early measurement to NR CA/MR-DC configuration. The example method can ensure that the UE 100 will have better services without any interruption or compromise to provide an enhanced 5G experience. The example method includes high technical value by prioritizing the secondary cell (that is, selecting a cell by prioritizing a plurality of candidate cells) supporting dominant services like bandwidth, HPUE or relaxed measurement support for the UE 100 in different scenarios. The example method solves one of the critical problems of prioritizing the secondary cell (that is, selecting a cell by prioritizing a plurality of candidate cells) based on the bandwidth, the HPUE or the relaxed measurement support for the device in different scenarios. The example method is novel and can help in achieving enhanced performance in the UE 100 by selecting a cell among a plurality of candidate cells for improving TPUT, coverage, and power saving.

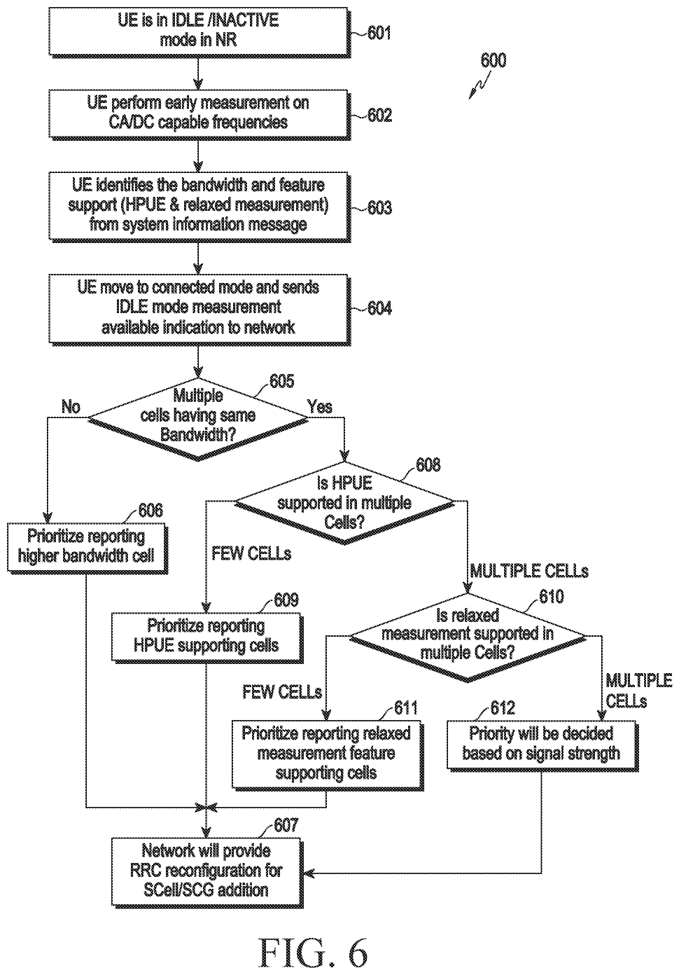

FIG. 6 is a flow diagram 600 illustrating an example method for prioritizing a secondary cell (that is, selecting a cell by prioritizing a plurality of candidate cells), according to various embodiments. At 601, the UE 100 is in an idle/inactive mode. At 602, the UE 100 receives idleModeMeasurements in NR SIB1 or LTE SIB2 or in NR RRC release message and performs the early measurement for fast CA/DC setup. At 603, while performing the idle mode measurement for fast CA/DC setup, the UE 100 identifies neighboring cells (for example, Ncell1, Ncell2, Ncell3 and Ncell4 exemplified in Table 1 below) and checks bandwidth, support of HPUE and support of relaxed measurement in all the neighbour cells through System Information Message (SIB). At 604, the UE 100 moves to the connected mode and sends the idle mode measurement available indication to the network. In an embodiment, the prioritization of the secondary cell (that is, selecting a cell by prioritizing a plurality of candidate cells) is based on the maximum bandwidth, the HPUE, or the relaxed measurement support to provide a better 5G experience. At 605, the UE 100 checks for multiple cells having the same bandwidth. At 606, upon not detecting multiple cells with the same bandwidth, the UE prioritizes reporting of the higher bandwidth cell. At 607, the network provides the RRC reconfiguration for the SCell/SCG addition.

At 605, if two or more cells are determined to support the same higher bandwidth, then the UE 100 prioritizes in an order of cells supporting the HPUE feature followed by cells supporting the relaxed measurement feature. Further, the UE 100 intelligently prioritizes the cells based on “cellEdgeEvaluation-r16” IE in relaxed measurement IE, where the UE 100 determines its position with respect to the gNB and determines the cell edge. At 608 and 609, in such cases of the cell edge, the HPUE will be prioritized for reporting for fast CA/DC setup, otherwise, in the case of a near cell at 608, 610 and 612, the cells with relaxed measurement feature support will be prioritized for reporting for fast CA/DC setup. If the neighbour cells do not support HPUE or relaxed measurement feature, then the UE 100 chooses the cell based on the bandwidth and the traditional method on basis of signal factors such as RSRP/RSRQ/SINR. If all cells support high bandwidth along with HPUE & relaxed measurement, then priority will be decided based on the signal strength.

The example embodiments provide better TPUT by selecting the maximum bandwidth cell during Release-16 Early measurement for fast DC/CA setup. Further, HPUE-supported cell preference during early measurement for fast DC/CA setup will ensure better coverage and improved UL TPUT. For power saving, the UE will consider Rel-16 and Rel-17 relaxed measurement-supported cell to reduce the measurement frequency of DC/CA cells. The example embodiments improve device performance in terms of throughput and cell coverage along with power saving based on the selection of cells during early measurement for fast DC/CA setup. The example embodiments defines a mechanism for the UE to prioritize NR cells supporting early measurement based on bandwidth, HPUE support or relaxed Measurement feature, which improves a UE's performance with respect to throughput, coverage, and power saving.

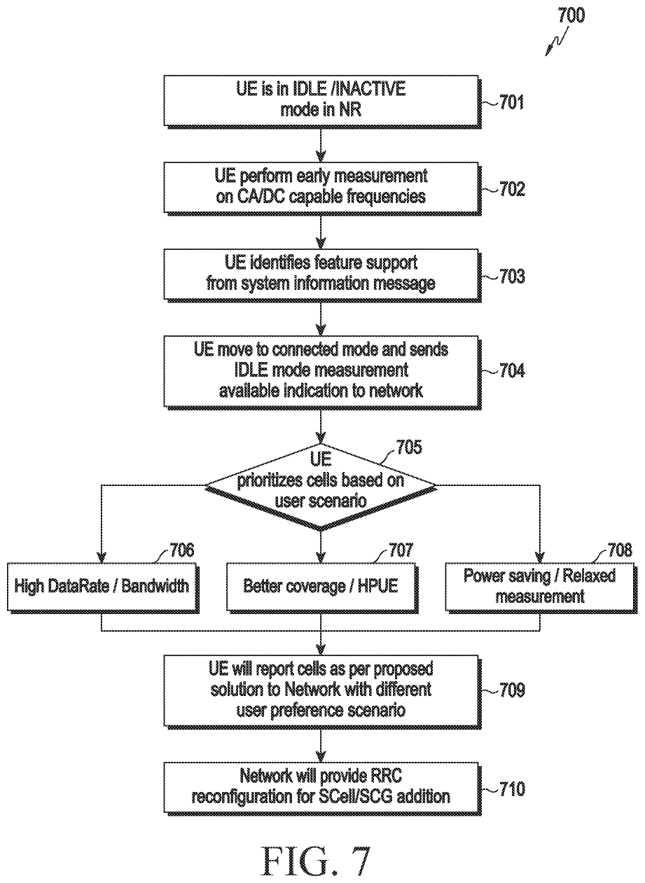

FIG. 7 is a flow diagram 700 illustrating an example method for prioritizing a secondary cell (that is, selecting a cell by prioritizing a plurality of candidate cells) based on a user preference, according to various embodiments. At 701, the UE 100 is in the idle/inactive mode. At 702, the UE 100 receives the idleModeMeasurements in the NR SIB1 or LTE SIB2 or in NR RRC release message and performs the early measurement for fast CA/DC setup. At 703, while performing the idle mode measurement for fast CA/DC setup, the UE 100 identifies neighboring cells (for example, Ncell1, Ncell2, Ncell3, Ncell4 exemplified in Table 1 below) and checks the bandwidth, the support of the HPUE and the support of the relaxed measurement in all the neighbor cells through System Information Message (SIB).

At 704, the UE 100 moves to the connected mode and sends the idle mode measurement available indication to the network. At 705, the UE 100 prioritizes the cells (that is, selecting a cell by prioritizing a plurality of candidate cells) based on the user scenario. At 706, and 709, the UE 100 chooses the cell with high data rate/bandwidth and reports the cells to the network as per the user scenario. At 707 and 709, the UE 100 chooses the cell with better coverage/HPUE and reports the cells to the network as per the user scenario. At 708 and 709, the UE 100 chooses the cell with Power saving/relaxed measurement, and reports the cells to the network as per the user scenario. At 710, the network provides the RRC reconfiguration for SCell/SCG addition.

Consider an example scenario as follows. The UE 100 is in the idle/inactive mode and performs cell measurement on the early measurement frequencies configured by the network. Consider, the neighbour cells listed in Table 1 are detected during the idle measurement for early reporting. Assume the UE 100 found 4 NR cells (NCell1, NCell2, NCell3, NCell4) in the scan result.

TABLE 1

| | NR | | Relaxed | | |
|---|---|---|---|---|---|
| | Frequency/ | Signal | Measurement | HPUE | Bandwidth |
| Index | Cell | Strength | Support | Support | (MHz) |
| 1 | NCell1 | −79 dBm | Yes | Yes | 100 |
| 2 | NCell2 | −78 dBm | No | No | 80 |
| 3 | NCell3 | −80 dBm | Yes | Yes | 100 |
| 4 | NCell4 | −83 dBm | Yes | Yes | 100 |

A ranking of the cells for reporting for fast CA/DC setup and selection of Ncell2 for SCell/SCG addition as per conventional 3GPP specification is given in Table 2. As per existing implementation, the UE 100 would measure the configured NR frequencies (irrespective of bandwidth and feature support like HPUE & relaxed Measurement supported or not) and report the cells to the network based on the signal strength for fast MR-DC/CA configuration. In this example, NCell2 is the strongest which will be reported in the early measurement report based on existing 3GPP specifications.

TABLE 2

| Index | NR Cells |
|---|---|
| 1 | NCell2 |
| 2 | NCell1 |
| 3 | NCell3 |
| 4 | NCell4 |

Prioritization of the cells based on HPUE support for fast CA/DC setup and selection of Ncell1 for SCell/SCG addition as per various example embodiments is shown in Table 3. With the example embodiments, since multiple cells have a same bandwidth and features support, the UE 100 prioritizes the NR cells with best signal strength among these cells for fast DC/CA setup. In this example, the Ncell1, Ncell3 and Ncell4 all have same bandwidth and same feature support. The UE 100 prioritizes reporting NCell1 for early measurement for fast CA/DC setup as Ncell1 is having best signal among Ncell1, Ncell3, and Ncell4.

TABLE 3

| | NR | | Relaxed | | |
|---|---|---|---|---|---|
| | Frequency/ | Signal | Measurement | HPUE | Bandwidth |
| Index | Cell | Strength | support | Support | (MHz) |
| 1 | NCell1 | −79 dBm | Yes | Yes | 100 |
| 2 | NCell3 | −80 dBm | Yes | Yes | 100 |
| 3 | NCell4 | −83 dBm | Yes | Yes | 100 |
| 4 | NCell2 | −78 dBm | No | No | 80 |

The various actions, acts, blocks, steps, or the like in the flow diagrams 500, 600, and 700 may be performed in the order presented, in a different order, or simultaneously. Further, in various embodiments, some of the actions, acts, blocks, steps, or the like may be omitted, added, modified, skipped, or the like without departing from the scope of the disclosure.

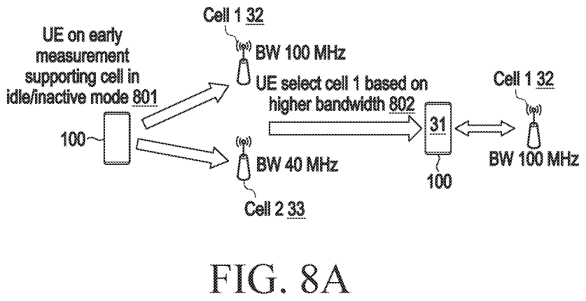

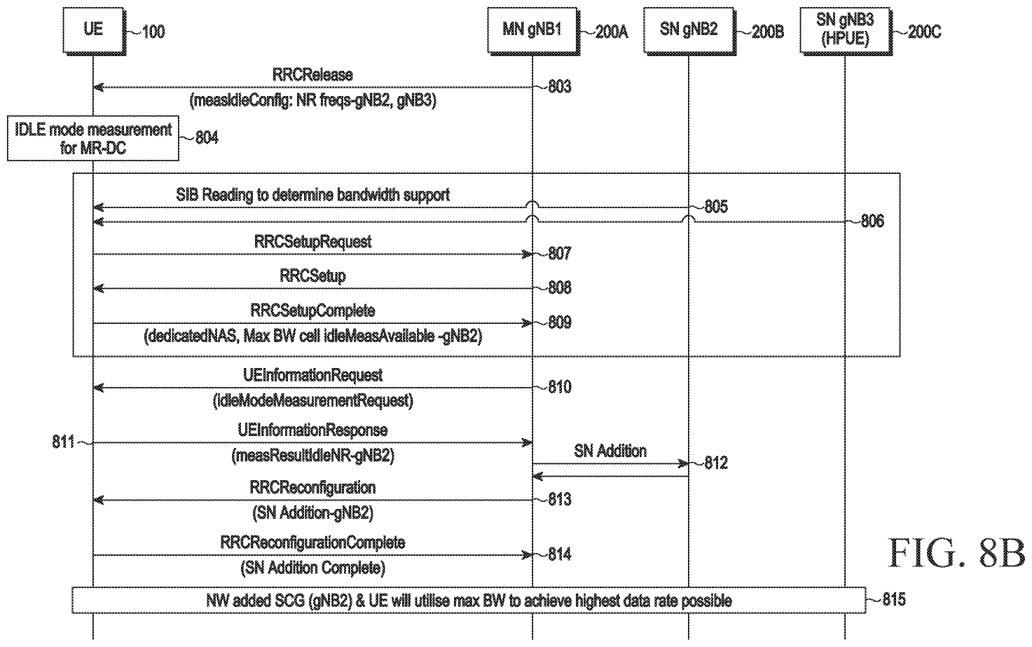

FIG. 8A illustrates a proposed solution for a problem in the early measurement of the high bandwidth, according to various embodiments. At 801, the UE 100 is camped on the NR cell supporting early measurement in the idle/inactive mode. The UE 100 requires the secondary cell addition for high data rate service triggered. The network configures multiple candidate cells 32, 33. The UE 100 can select either the cell 1 (32) or the cell 2 (33) as both satisfy a condition for measurement report for SCell addition. With the proposed method, the UE 100 reads the SIB1 for these candidate neighbor cells 32, 33 to determine cell bandwidth and prioritize the neighbor cells 32, 33 based on a maximum bandwidth. Later during the RRC connection establishment, the UE 100 informs the network availability of early measurement cells in the RRC complete message. Further, the network requests these measurements for quick setup of CA/MR-DC using UEInformationRequest.

At 802, in response to using the UEInformationResponse message, the UE 100 shares the measurement of the cell 1 (32) with maximum bandwidth with the network for the secondary cell addition. As a result, the UE 100 will have additional resources from the maximum bandwidth cell (32) and achieve the highest possible downlink TPUT for the UE 100 at that time compared to any random cell selected as per the current 3GPP specification. Thus, the example method enhances user experience and improves data throughput of the UE 100 to run any service requested smoothly.

FIG. 8B is a sequence diagram illustrating signaling between the UE 100, a master node gNB (e.g., MN gNB1 (200A)) and two secondary node gNBs (e.g., SN gNB2 (200B) and SN gNB3 (200C)) for the early measurement for the high bandwidth, according to various embodiments. From 803 to 804, the network configures MR-DC early measurement (Rel-16 MR-DC enhancements) with the UE 100. At 803, the UE 100 receives an RRCRelease message including measIdleConfig: NR freqs-gNB2, gNB3 from the master node gNB (i.e. MN gNB1 (200A)). At 804, the UE 100 is in the idle mode measurement for MR-DC.

From 805 to 809, the UE 100 reads the SIB1 to determine bandwidth support and includes the idleMeasAvailable in RRC setup complete message with gNB2 measurements. At 805 and 806, the UE 100 reads the SIB to determine bandwidth support of the two secondary node gNBs (i.e. SN gNB2 (200B), and SN gNB3 (200C)). At 807, the UE 100 sends the RRCSetupRequest message to the MN gNB1 (200A). At 808, the UE 100 receives an RRCSetup message from the MN gNB1 (200A). At 809, the UE 100 sends an RRCSetupComplete message that includes dedicated NAS, Max BW cell idleMeasAvailable-gNB2 to the MN gNB1 (200A).

From 810 to 815, the network adds the gNB2 as SCG based on which has the highest bandwidth support based on the early measurement, so the UE 100 can utilize maximum bandwidth support. At 810, the UE 100 receives the UEInformationRequest message including idleModeMeasurementRequest from the MN gNB1 (200A). At 811, the UE 100 sends the UEInformationResponse message including measResultIdleNR-gNB2 to the MN gNB1 (200A). At 812, the MN gNB1 (200A) configures the SN gNB2 (200B) for the SN addition. At 813, the UE 100 receives an RRCReconfiguration including SN Addition-gNB2 from the MN gNB1 (200A). At 814, the UE 100 sends the RRCReconfigurationComplete message including SN Addition Complete to the MN gNB1 (200A). At 815, the network adds the SCG (gNB2), and the UE 100 utilizes maximum bandwidth to achieve the highest data rate possible.

Consider an example scenario as follows. The UE 100 is in the idle/inactive mode and performs cell measurement on the early measurement frequencies configured by the network. Consider, the neighbor cells listed in Table 4 are detected during the idle measurement for early reporting. Assume the UE 100 found 4 NR cells (NCell1, NCell2, NCell3, NCell4) in the scan result.

TABLE 4

| | NR | Signal | |
|---|---|---|---|
| Index | Frequency/Cell | Strength | Bandwidth(MHz) |
| 1 | NCell1 | −79 dBm | 80 |
| 2 | NCell2 | −77 dBm | 60 |
| 3 | NCell3 | −81 dBm | 100 |
| 4 | NCell4 | −80 dBm | 80 |

A ranking of the cells for reporting for fast CA/DC setup and selection of Ncell2 for SCell/SCG addition as per conventional 3GPP specification is given in Table 5. As per existing implementation, the UE 100 would measure the configured NR frequencies (irrespective of higher bandwidth support or not) and report the cells to the network based on the signal strength for fast MR-DC/CA configuration. In this example, the NCell2 is the strongest which will be reported in the early measurement report based on the existing 3GPP specifications.

TABLE 5

| Index | NR Cells |
|---|---|
| 1 | NCell2 |
| 2 | NCell1 |
| 3 | NCell4 |
| 4 | NCell3 |

Prioritization of the cells based on the bandwidth support for fast CA/DC setup and selection of Ncell1 for SCell/SCG addition as per the example embodiments is shown in Table 6. With the example embodiments, the UE 100 prioritizes the NR cells supporting high bandwidth (i.e. NCell3 and NCell4) and reports to the network for the fast DC/CA setup. In this example, the UE 100 requires the secondary cell which can be satisfied with NCell3 by providing maximum bandwidth. So, the UE 100 will prioritize reporting NCell3 for early measurement for fast CA/DC setup. Even though the NCell3 is not the best signal cell, the UE 100 chooses this cell as it is only marginally lower (<5 dBm) than the best cell.

TABLE 6

| | NR | | Bandwidth |
|---|---|---|---|
| Index | Frequency/Cell | Signal Strength | (MHz) |
| 1 | NCell3 | −81 dBm | 100 |
| 2 | NCell4 | −80 dBm | 80 |
| 3 | NCell1 | −79 dBm | 80 |
| 4 | NCell2 | −77 dBm | 60 |

The UE 100 is in the idle/inactive mode and receives idleModeMeasurements in NR SIB1 or LTE SIB2 or in NR RRC Release message for early measurement for fast CA/DC setup. While performing the idle mode measurement for fast CA/DC setup, the UE 100 identifies 4 cells (as per example say Ncell1, Ncell2, Ncell3, Ncell4) and it will check for the bandwidth of all the neighbour cell through SIB and determine the higher bandwidth neighbour cell for prioritization. While going to connected mode, the UE 100 informs the network with the availability of the idle mode measurement reports for fast CA/DC setup. Once the network asks for “idleModeMeasurementReq” through the UEInformationRequest message, the UE 100 prioritizes reporting the higher bandwidth cells in the UEInformationResponse message.

Based on the higher bandwidth cells reported by the UE 100, the network will configure the CA/DC with a higher bandwidth cell. As per the example here, the UE 100 found that NCell3 has higher bandwidth than other neighbour cells (Ncell1, Ncell2 and Ncell4). Further, the UE 100 reports the Ncell3 in UEInformationResponse message for fast CA/DC setup. With the example embodiments, the UE 100 will get the higher throughput in CA/DC whenever there is a chance of selecting the higher bandwidth cell. In this case, all the neighbour cells have the same bandwidths, then UE chooses the cell on the traditional method according to signal factors such as RSRP/RSRQ/SINR.

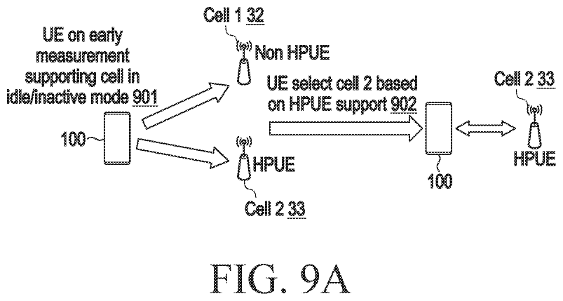

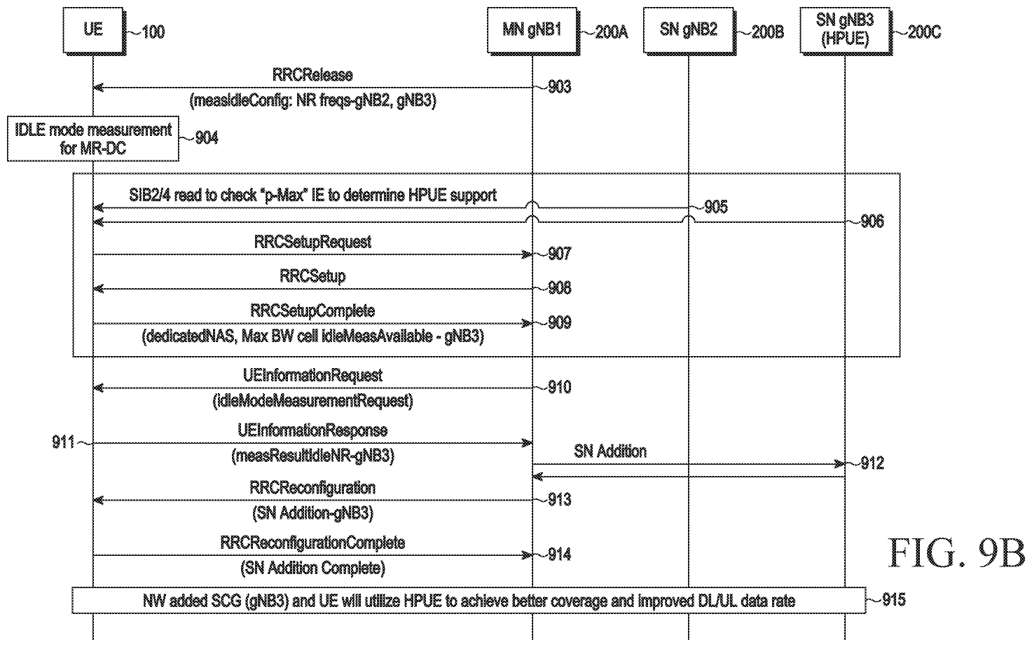

FIG. 9A illustrates a proposed solution for a problem in the early measurement for better coverage and uplink throughput, according to various embodiments. At 901, the UE 100 is camped on the NR cell supporting early measurement in the idle/inactive mode. The UE 100 requires the secondary cell addition for high data rate service triggered. The network configures the multiple candidate cells 32, 33. The UE 100 can select either cell 1 (32) or cell 2 (33) as both satisfy the condition for the measurement report for the SCell addition. In an example embodiment, the UE 100 reads the SIB2 and SIB4 for the value of “p-Max” IE to determine HPUE support in neighboring cells and prioritize the cells 32, 33 based on the support of the HPUE. Later during the RRC connection establishment, the UE 100 informs the network about the availability of the early measurement cells in the RRC complete message. Further, the network requests these measurements for quick setup of CA/MR-DC using UEInformationRequest.

At 902, in response to using the UEInformationResponse message, the UE 100 shares the measurement of the cell 33 supporting the HPUE with the network for the secondary cell addition. As a result, the UE 100 will have better coverage in the cell edge area and better reception/transmission packet for uplink with higher TX power compared to the non-HPUE cell 32 selected as per the current 3GPP specification. Thus the example embodiment ensures better coverage and improves the uplink data throughput of the UE 100 in the cell edge conditions.

FIG. 9B is a sequence diagram illustrating signaling between the UE, the master node gNB (i.e. MN gNB1 (200A)) and the two secondary node gNBs (i.e. SN gNB2 (200B), and SN gNB3 (200C)) for better coverage and uplink throughput, according to various embodiments. From 903 to 904, the network configures MR-DC early measurement (Rel-16 MR-DC enhancements) with the UE 100. At 903, the UE 100 receives the RRCRelease message including measIdleConfig: NR freqs-gNB2, gNB3 from the master node gNB (e.g., MN gNB1 (200A)). At 904, the UE 100 is in the idle mode measurement for MR-DC.

From 905 to 909, the UE 100 reads “p-Max” IE from SIB2 and SIB4 to determine HPUE support, and includes the idleMeasAvailable in RRC setup complete message with gNB3 measurements. At 905 and 906, the UE 100 reads the SIB2/4 read to check “p-Max” IE to determine HPUE support of the two secondary node gNBs (e.g., SN gNB2 (200B) and SN gNB3 (200C)). At 907, the UE 100 sends the RRCSetupRequest message to the MN gNB1 (200A). At 908, the UE 100 receives the RRCSetup message from the MN gNB1 (200A). At 909, the UE 100 sends the RRCSetupComplete message including the dedicated NAS, Max BW cell idleMeasAvailable-gNB3 to the MN gNB1 (200A).

From 910 to 915, the network adds the gNB3 as the SCG based on which has HPUE support based on the early measurement, so the UE 100 can utilize higher transmission power in the uplink. At 910, the UE 100 receives the UEInformationRequest message including idleModeMeasurementRequest from the MN gNB1 (200A). At 911, the UE 100 sends the UEInformationResponse message including measResultIdleNR-gNB3 to the MN gNB1 (200A). At 912, the MN gNB1 (200A) configures the SN gNB3 (200C) for the SN addition. At 913, the UE 100 receives RRCReconfiguration including SN Addition-gNB3 from the MN gNB1 (200A). At 914, the UE 100 sends the RRCReconfigurationComplete message including SN Addition Complete to the MN gNB1 (200A). At 915, the network adds the SCG (gNB3), and the UE 100 utilizes maximum HPUE to achieve better coverage and improved downlink/uplink data rate.

Consider an example scenario as follows. The UE 100 is in the idle/inactive mode and performs cell measurement on the early measurement frequencies configured by the network. Consider, the neighbor cells listed in Table 7 are detected during the idle measurement for early reporting. Assuming the UE 100 found 4 NR cells (NCell1, NCell2, NCell3, NCell4) in the scan result.

TABLE 7

| | NR | | |
|---|---|---|---|
| Index | Frequency/Cell | Signal Strength | HPUE support |
| 1 | NCell4 | −80 dBm | Yes |
| 2 | NCell3 | −81 dBm | Yes |
| 3 | NCell1 | −79 dBm | No |
| 4 | NCell2 | −76 dBm | No |

A ranking of the cells for reporting for fast CA/DC setup and selection of Ncell2 for SCell/SCG addition as per conventional 3GPP specification is shown in Table 8. As per existing implementation, the UE 100 would measure the configured NR frequencies (irrespective of whether HPUE is supported or not) and report the cells to the network based on the signal strength for fast MR-DC/CA configuration. In this example, NCell2 is the strongest, which will be reported in the early measurement report based on the existing 3GPP specifications.

TABLE 8

| Index | NR Cells |
|---|---|
| 1 | NCell2 |
| 2 | NCell1 |
| 3 | NCell3 |
| 4 | NCell4 |

Prioritization of the cells based on HPUE support for fast CA/DC setup and selection of Ncell4 for SCell/SCG addition as per the proposed method is shown in Table 9. In an example embodiment, the UE 100 prioritizes the NR cells supporting the HPUE (i.e. NCell3 and NCell4) and reports to the network for fast DC/CA setup. In this example, UE 100 requires the secondary cell supporting HPUE which is NCell4. So, the UE 100 prioritizes reporting the NCell4 for early measurement for fast CA/DC setup. Even though the NCell4 is not the best signal cell, the UE 100 chooses this cell as it is only marginally lower (<5 dBm) than the best cell.

TABLE 9

| | NR | | |
|---|---|---|---|
| Index | Frequency/Cell | Signal Strength | HPUE support |
| 1 | NCell4 | −80 dBm | Yes |
| 2 | NCell3 | −81 dBm | Yes |
| 3 | NCell1 | −79 dBm | No |
| 4 | NCell2 | −76 dBm | No |

The UE 100 is in idle/inactive mode and receives the idleModeMeasurements in the NR SIB1 or the LTE SIB2 or in the NR RRC Release message for early measurement for the fast CA/DC setup. While performing the idle mode measurement for fast CA/DC setup, the UE (100) identifies 4 cells (for example, Ncell1, Ncell2, Ncell3, Ncell4) and it will check the support of HPUE in all the neighbour cells through SIB and determines the HPUE supported neighbour cells for prioritization. While going to connected mode, the UE 100 informs the network with the availability of the idle mode measurement reports for fast CA/DC setup. Once the network asks for “idleModeMeasurementReq” through the UEInformationRequest message, the UE 100 prioritizes reporting the HPUE-supported cells in the UEInformationResponse message.

Based on the HPUE-supported cells reported by the UE 100, the network configures the CA/DC with the HPUE cell which will improve coverage and Tx power in the UE 100 along with better UL/DL throughput in the cell edge area. As per this example, the UE 100 found that NCell3 & Ncell4 have HPUE support rather than other neighbour cells (Ncell1 & Ncell2). The UE 100 reports Ncell3 and Ncell4, in UEInformationResponse message for fast CA/DC setup. With this method, the UE 100 obtains improved coverage and transmission power along with better UL/DL throughput in the cell edge area in CA/DC whenever there is chance of selecting the HPUE cell. In a case in which, all the neighbour cells support the HPUE, then the UE 100 chooses the cell on the traditional method according to signal factors such as RSRP/RSRQ/SINR.

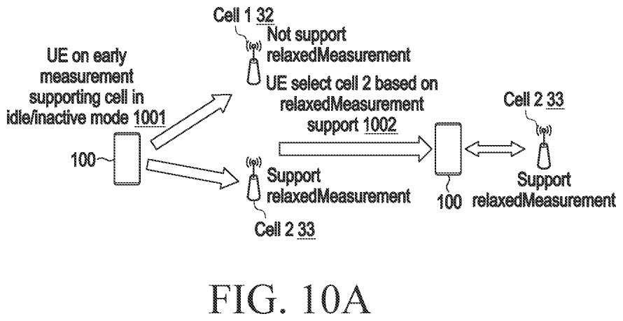

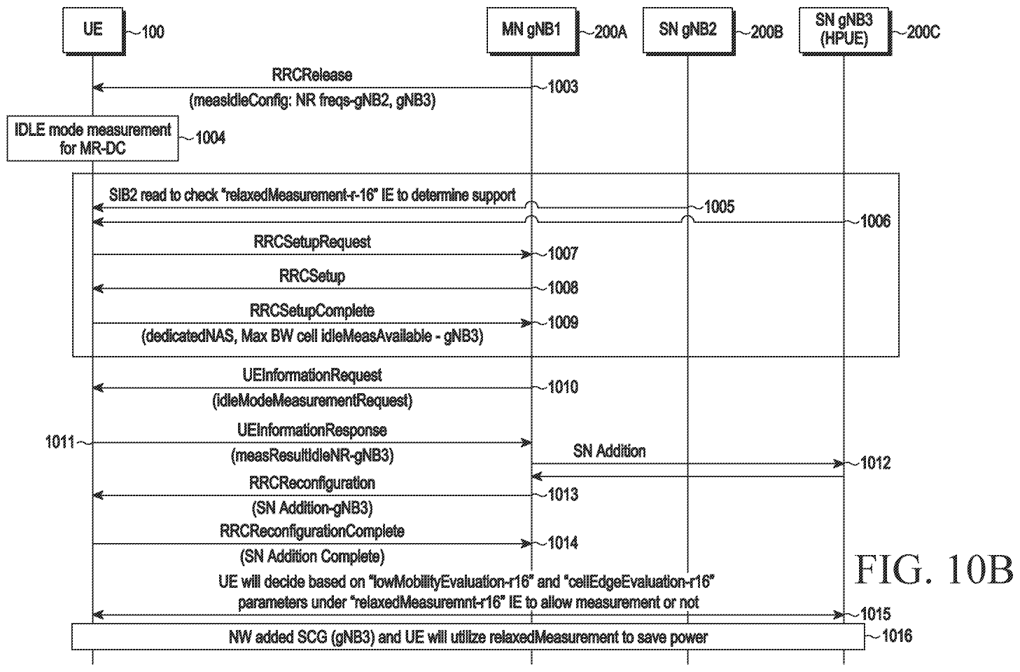

FIG. 10A illustrates a proposed example solution for a problem in the early measurement for power saving, according to various embodiments. At 1001, the UE 100 is camped on the NR cell supporting early measurement in the idle/inactive mode. The UE 100 requires the secondary cell addition for high data rate service triggered. The network configures multiple candidate cells 32, 33. The UE 100 can select either the cell 1 (32) or the cell 2 (33) as both satisfies the condition for measurement report for SCell addition. With the proposed method, the UE 100 reads the SIB2 for “relaxedMeasurement-r16” IE to determine if SCells 32, 33 allow relaxation of the RRM measurement requirements and prioritizes these cells 32, 33 based on the support for the relaxedMeasurement feature. Later during the RRC connection establishment, the UE 100 informs the network about the availability of early measurement cells in the RRC complete message. Further, the network requests these measurements for quick setup of CA/MR-DC using UEInformationRequest.

At 1002, in response to using the UEInformationResponse message, the UE 100 shares the measurement of cell 33 supporting the relaxedMeasurement-r16 with the network for the secondary cell addition. As a result, the UE 100 determines if the UE 100 is currently in low mobility or not in the cell edge area based on “lowMobilityEvaluation-r16” & “cellEdgeEvaluation-r16” parameters under the “relaxedMeasurement-r16” IE. Using this IE, as per release-17 TS38.331, the UE 100 reduces the frequency of the measurement in connected mode to save power, which helps with power saving and provides a prolonged battery life experience to the UE 100.

FIG. 10B is a sequence diagram illustrating signaling between the UE, the master node gNB (e.g., MN gNB1 (200A)) and the two secondary node gNBs (e.g., SN gNB2 (200B), and SN gNB3 (200C)) for the early measurement for the power saving, according to various embodiments. From 1003 to 1004, the network configures MR-DC early measurement (Rel-16 MR-DC enhancements) with the UE 100. At 1003, the UE 100 receives the RRCRelease message that includes measIdleConfig: NR freqs-gNB2, gNB3 from the master node gNB (i.e. MN gNB1 (200A)). At 1004, the UE 100 is in the idle mode measurement for MR-DC.

From 1005 to 1009, the UE 100 reads the SIB2 to check the “relaxedMeasurement-r-16” IE to determine the relaxedMeasurement support and includes the idleMeasAvailable in the RRC setup complete message with gNB3 measurements. At 1005 and 1006, the UE 100 reads the SIB2 read to check the “relaxedMeasurement-r-16” IE to determine the support of the two secondary node gNBs (i.e. SN gNB2 (200B), and SN gNB3 (200C)). At 1007, the UE 100 sends the RRCSetupRequest message to the MN gNB1 (200A). At 1008, the UE 100 receives the RRCSetup message from the MN gNB1 (200A). At 1009, the UE 100 sends the RRCSetupComplete message including dedicated NAS, Max BW cell idleMeasAvailable-gNB3 to the MN gNB1 (200A).

From 1010 to 1015, the network adds the gNB3 as the SCG using which has the relaxedMeasurement support based on the early measurement, so the UE 100 can conserve the power. At 1010, the UE 100 receives the UEInformationRequest message including idleModeMeasurementRequest from the MN gNB1 (200A). At 1011, the UE 100 sends the UEInformationResponse message including measResultIdleNR-gNB3 to the MN gNB1 (200A). At 1012, the MN gNB1 (200A) configures the SN gNB3 (200C) for the SN addition. At 1013, the UE 100 receives the RRCReconfiguration including SN Addition-gNB3 from the MN gNB1 (200A). At 1014, the UE 100 sends the RRCReconfigurationComplete message including the SN Addition Complete to the MN gNB1 (200A). At 1015, the UE 100 decides based on the “lowMobilityEvaluation-r16” and the “cellEdgeEvaluation-r16” parameters under the “relaxedMeasurement-r16” IE to allow measurement or not. At 1016, the network adds the SCG (gNB3), and the UE 100 utilizes the relaxedMeasurement to save power.

Consider an example scenario as follows. The UE 100 is in the idle/inactive mode and performs cell measurement on the early measurement frequencies configured by the network. Consider, the neighbor cells listed in Table 10 are detected during the idle measurement for early reporting. Assume the UE 100 found 4 NR cells (NCell1, NCell2, NCell13, NCell4) in the scan result.

TABLE 10

| | | | Relaxed |
|---|---|---|---|
| | NR | | Measurement |
| Index | Frequency/Cell | Signal Strength | Support |
| 1 | NCell1 | −79 dBm | No |
| 2 | NCell2 | −78 dBm | No |
| 3 | NCell3 | −80 dBm | Yes |
| 4 | NCell4 | −83 dBm | Yes |

A ranking of the cells for reporting for fast CA/DC setup and selection of Ncell2 for SCell/SCG addition as per conventional 3GPP specification is given in Table 11. As per existing implementation, the UE 100 would measure the configured NR frequencies (irrespective of whether relaxed Measurement is supported or not) and report the cells to the network based on the signal strength for fast MR-DC/CA configuration. In this example, NCell2 is the strongest which will be reported in the early measurement report based on the existing 3GPP specifications.

TABLE 11

| Index | NR Cells |
|---|---|
| 1 | NCell2 |
| 2 | NCell1 |
| 3 | NCell3 |
| 4 | NCell4 |

Prioritization of the cells based on HPUE support for fast CA/DC setup and selection of Ncell1 for SCell/SCG addition as per the proposed method is given in Table 12. With the proposed method, the UE 100 prioritizes the NR cells supporting the HPUE (i.e. NCell3 and NCell4) and reports to the network for fast DC/CA setup. In this example, the UE 100 requires the secondary cell supporting Relaxed Measurement which is NCell3. So, the UE 100 prioritizes reporting the NCell3 for early measurement for fast CA/DC setup. Even though the NCell4 is not the best signal cell, the UE 100 chooses this cell as it is only marginally lower (<5 dBm) than the best cell.

TABLE 12

| | | | Relaxed |
|---|---|---|---|
| | NR | Signal | Measurement |
| Index | Frequency/Cell | Strength | support |
| 1 | NCell3 | −80 dBm | Yes |
| 2 | NCell4 | −83 dBm | Yes |
| 3 | NCell1 | −79 dBm | No |
| 4 | NCell2 | −78 dBm | No |

The UE 100 is in the idle/inactive mode and receives the idleModeMeasurements in the NR SIB1 or the LTE SIB2 in the NR RRC Release message for early measurement for fast CA/DC setup. While performing the idle mode measurement for fast CA/DC setup, the UE 100 has found 4 cells (as per example say Ncell1, Ncell2, Ncell3, Ncell4) and it will check the support of release-16 relaxed measurement in all the neighbour cells through SIB and determines the relaxed measurement supported neighbour cells for prioritization. While going to connected mode, the UE 100 informs the network with the availability of the idle mode measurement reports for fast CA/DC setup. Once the network asks for “idleModeMeasurementReq” through the UEInformationRequest message, the UE will prioritize reporting the relaxed measurement supported cells in the UEInformationResponse message.

Based on the relaxed measurement supported cells reported by the UE 100, the network configures the CA/DC with the relaxed measurement cell using which UE will save power by reducing the frequency of measurement. As per this example, the UE 100 found that NCell3 & Ncell4 have the relaxed measurement feature support than other neighbour cells (Ncell1 & Ncell2). The UE 100 reports Ncell3 and Ncell4, in UEInformationResponse message for fast CA/DC setup. With this method, the UE 100 can reduce power consumption by reducing the measurement in stationary and not in cell edge conditions in CA/DC whenever there is a chance. In case all the neighbour cells support the relaxed measurement feature, then the UE 100 chooses the cell on the traditional method according to signal factors such as RSRP/RSRQ/SINR.

The example embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

While the disclosure has been illustrated and described with reference to various example embodiments, it will be understood that the various example embodiments are intended to be illustrative, not limiting. It will be further understood by those of ordinary skill in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for selecting a cell by a user equipment (UE) in a wireless communication system, the method comprising:
receiving first configuration information for early measurement to be performed while the UE is in an idle state or an inactive state;
identifying, based on the first configuration information, a plurality of candidate cells for the early measurement among neighboring cells of the UE;
receiving, from each candidate cell of the plurality of candidate cells, second configuration information including at least one of bandwidth support information, high power user equipment (HPUE) support information or relaxed measurement support information; and
selecting a cell by prioritizing the plurality of candidate cells, based on a signal strength of said each candidate cell and the second configuration information.

2. The method of claim 1, wherein the selected cell is a cell to be added for a dual connectivity (DC)/carrier aggregation (CA) of the UE in the wireless communication system supporting the DC/CA.

3. The method of claim 2, wherein the UE receives the first configuration information from a primary cell on which the UE camped, and wherein the selected cell is a secondary cell for the DC/CA of the UE.

4. The method of claim 1, wherein the first configuration information includes available frequency information about at least one of a new radio (NR) or an evolved universal terrestrial radio access (EUTRA), the available frequency information corresponding to the plurality of candidate cells.

5. The method of claim 1, wherein selecting a cell by prioritizing the plurality of candidate cells comprises:
prioritizing the plurality of candidate cells based on the bandwidth support information and a signal strength of said each candidate cell; and
selecting the cell with a higher signal strength among at least one cell having a maximum bandwidth in the plurality of prioritized candidate cells.

6. The method of claim 1, wherein selecting a cell by prioritizing the plurality of candidate cells comprises:
prioritizing the plurality of candidate cells based on the HPUE support information and a signal strength of said each candidate cell; and
selecting the cell with a higher signal strength among at least one cell supporting HPUE in the plurality of prioritized candidate cells.

7. The method of claim 1, wherein selecting a cell by prioritizing the plurality of candidate cells comprises:
prioritizing the plurality of candidate cells based on the relaxed measurement support information and a signal strength of said each candidate cell; and
selecting the cell with a higher signal strength among at least one cell supporting a relaxed measurement in the plurality of prioritized candidate cells.

8. The method of claim 1, wherein prioritizing the plurality of candidate cells comprises:
prioritizing the plurality of candidate cells in order of satisfying criteria of the bandwidth support information, the HPUE support information and the relaxed measurement support information.

9. The method of claim 2, further comprising transmitting, to a base station of a primary cell of the UE, a radio resource control (RRC) message including information about the selected candidate cell;
receiving, from the base station, a request message for requesting measurement for the selected candidate cell;
transmitting, to the base station, a response message including a measurement result for the selected candidate cell; and
performing a RRC reconfiguration procedure with the selected candidate cell as a secondary cell for the DC/CA.

10. A user equipment (UE) in a wireless communication system, the UE comprising:
a communicator;
at least one processor; and
a memory storing instructions that, when executed by the at least one processor, cause the UE to:
receive first configuration information for early measurement to be performed while the UE is in an idle state or an inactive state;
identify, based on the first configuration information, a plurality of candidate cells for the early measurement among neighboring cells of the UE;
receive, from each candidate cell of the plurality of candidate cells, second configuration information including at least one of bandwidth support information, high power user equipment (HPUE) support information or relaxed measurement support information; and
select a cell by prioritizing the plurality of candidate cells, based on a signal strength of said each candidate cell and the second configuration information.

11. The UE of claim 10, wherein the selected cell is a cell to be added for a dual connectivity (DC)/carrier aggregation (CA) of the UE in the wireless communication system supporting the DC/CA.

12. The UE of claim 11, wherein the instructions cause the UE to receive the first configuration information from a primary cell on which the UE camped, and wherein the selected cell is a secondary cell for the DC/CA of the UE.

13. The UE of claim 10, wherein the first configuration information includes available frequency information about at least one of a new radio (NR) or an evolved universal terrestrial radio access (EUTRA), the available frequency information corresponding to the plurality of candidate cells.

14. The UE of claim 10, wherein the instructions cause the UE to:
prioritize the plurality of candidate cells based on the bandwidth support information and a signal strength of said each candidate cell; and
select the cell with a higher signal strength among at least one cell having a maximum bandwidth in the plurality of prioritized candidate cells.

15. The UE of claim 10, wherein the instructions cause the UE to:
prioritize the plurality of candidate cells based on the HPUE support information and a signal strength of said each candidate cell; and
select the cell with a higher signal strength among at least one cell supporting HPUE in the plurality of prioritized candidate cells.

16. The UE of claim 10, wherein the instructions cause the UE to:
prioritize the plurality of candidate cells based on the relaxed measurement support information and a signal strength of said each candidate cell; and
select the cell with a higher signal strength among at least one cell supporting a relaxed measurement in the plurality of prioritized candidate cells.

17. The UE of claim 10, wherein the instructions cause the UE to:
prioritize the plurality of candidate cells in order of satisfying criteria of the bandwidth support information, the HPUE support information and the relaxed measurement support information.

18. The UE of claim 11, wherein the instructions cause the UE to:
receive, from the base station, a request message for requesting measurement for the selected candidate cell;
transmit, to the base station, a response message including a measurement result for the selected candidate cell; and
perform a radio resource control (RRC) reconfiguration procedure with the selected candidate cell as a secondary cell for the DC/CA.

19. A non-transitory computer readable storage medium may include one or more programs, the one or more programs comprising instructions that, when executed by at least one processor, cause a user equipment (UE) in a wireless communication system to:
receive first configuration information for early measurement to be performed while the UE is in an idle state or an inactive state;
identify, based on the first configuration information, a plurality of candidate cells for the early measurement among neighboring cells of the UE;
receive, from each candidate cell of the plurality of candidate cells, second configuration information including at least one of bandwidth support information, high power user equipment (HPUE) support information or relaxed measurement support information; and
select a cell by prioritizing the plurality of candidate cells, based on a signal strength of said each candidate cell and the second configuration information.
